(19) United States
(12) Patent Application Publication
(10) Pub. No.: US 2013/0083518 A1
(43) Pub. Date: Apr. 4, 2013

(54) LIGHT SYSTEM FOR RETROFIT AND OTHER APPLICATIONS

(71) Applicant: Niranjan B. De Silva, Long Beach, CA (US)

(72) Inventor: Niranjan B. De Silva, Long Beach, CA (US)

(21) Appl. No.: 13/633,722

(22) Filed: Oct. 2, 2012

Related U.S. Application Data
(63) Continuation-in-part of application No. 13/252,071, filed on Oct. 3, 2011.
(60) Provisional application No. 61/542,420, filed on Oct. 3, 2011.

(51) Int. Cl. F21V 19/02; F21V 5/04; F21V 29/00

(52) U.S. Cl. 362/225

(57) ABSTRACT

An exemplary embodiment of a light system includes a plurality of elongated light modules each comprising a plurality of separate light emitting diodes (LEDs), at least one adjustable length bracket structure configured to fix each LED module in position within the box light housing, each bracket structure comprising a first, module engaging end for engaging an end of the LED module, a second, support wall engaging end for engaging against a wall of the box light housing structure, and a length adjustment mechanism for adjusting the distance between the first bracket end and the second bracket end. In an exemplary embodiment, the length adjustment mechanism includes a turnbuckle mechanism.

### CROSS-REFERENCE TO RELATED APPLICATION

This application claims the benefit of U.S. Provisional Application No. 61/542,420 filed Oct. 3, 2011, hereby incorporated by reference.

### BACKGROUND

This invention relates to lighting applications such as area lighting and box lighting employing light sources such as light-emitting-diodes (LEDs), and in an exemplary embodiment to box lights used to illuminate canopies in gas stations and parking lots.

### BRIEF DESCRIPTION OF THE DRAWINGS

Features and advantages of the disclosure will readily be appreciated by persons skilled in the art from the following detailed description when read in conjunction with the drawing wherein:

FIG. 1 is an isometric, partially broken-way view of an exemplary embodiment of a box light system employing a set of light-emitting-diode modules as illumination sources, showing the top and sides of the box light system.

FIG. 2 is a bottom isometric view of the box light system of FIG. 1, showing the LEDS positioned to illuminate an area beneath the box system.

FIG. 3A is a diagrammatic exploded isometric view of an LED module employed in the system of FIG. 1. FIG. 3B illustrates a simplified electrical schematic block diagram for the system of FIG. 1.

FIG. 4 is a diagrammatic isometric view showing an exemplary turnbuckle bracket connected to one end of an LED module.

FIGS. 5A and 5B are isometric views of the turnbuckle bracket shown in FIGS. 1, 2 and 4, showing each end of the bracket in detail.

### DETAILED DESCRIPTION

In the following detailed description and in the several figures of the drawing, like elements are identified with like reference numerals. The figures are not to scale, and relative feature sizes may be exaggerated for illustrative purposes.

This application is related to provisional application serial number 61/389,646, filed Oct. 4, 2010, the entire contents of which are incorporated herein by this reference.

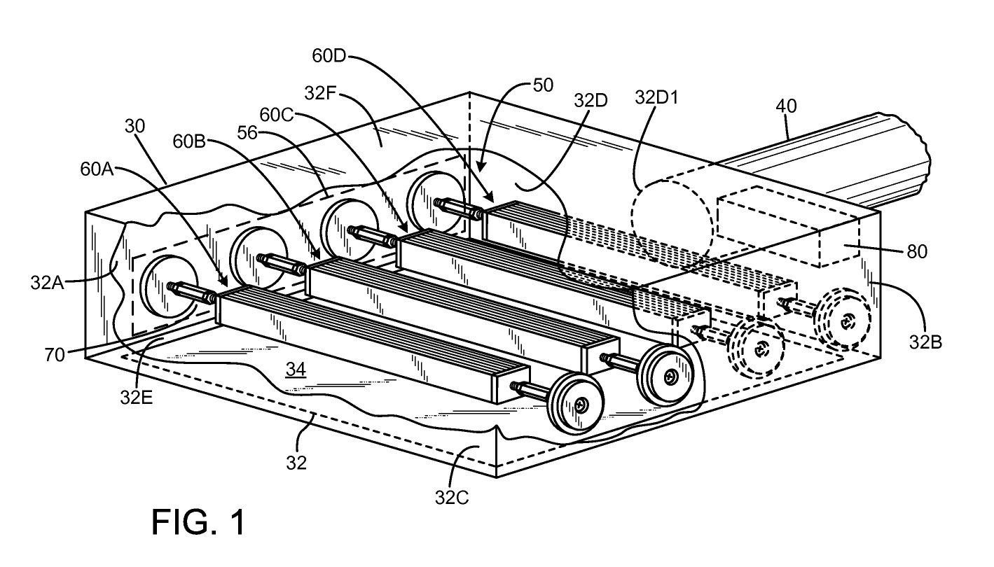

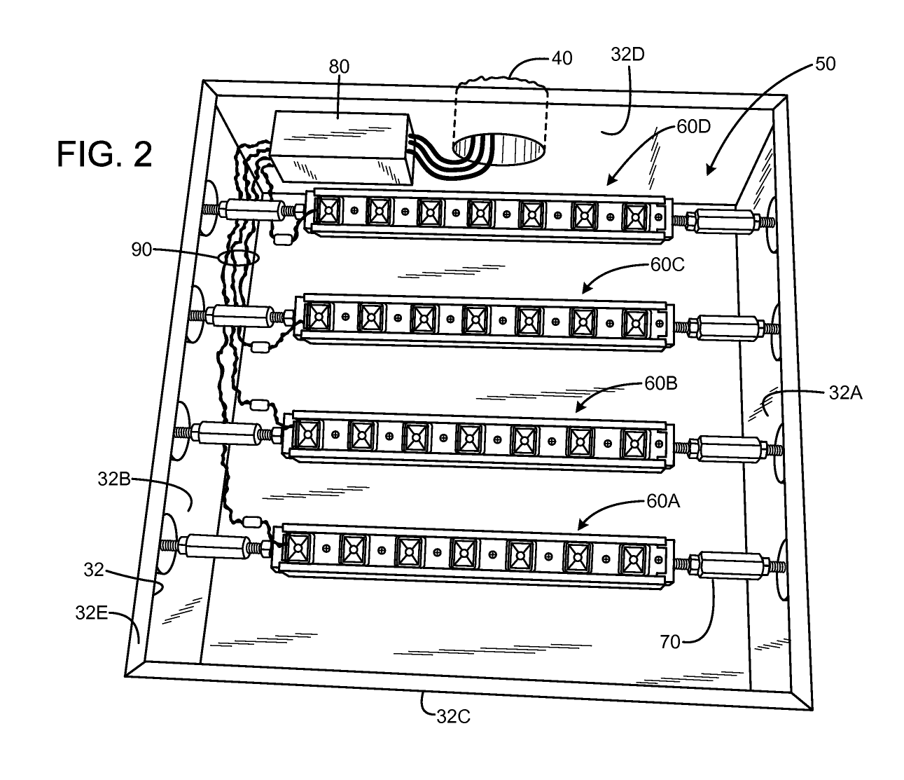

An exemplary embodiment of a light system 50 is illustrated in FIGS. 1-5B. This example is configured for retrofit to a box light, but the subject matter disclosed herein may be employed in other types and forms of lighting fixtures as well. The light system 50 includes a plurality of LED modules 60A, 60B, 60C and 60D, and an electrical module 80 connected to the LED modules by wiring 90 (FIG. 2) to provide electrical power to the LED light modules. The light system 50 with its LED modules is configured to install in a box light housing 30, which has an open window 32 in its bottom wall 32E, on which may be fitted a lens or transparent window 34, through which light emitted by the light modules is passed.

In an exemplary embodiment, the light system 50 is a retrofit system for installation in an installed box light, which may have had conventional light sources removed to make room for the light system 50 components. The LED modules include module mounting structures which allow the modules to be mounted in the box without other fasteners. Alternatively, the box 30 may be of new construction, and the light system installed in the box.

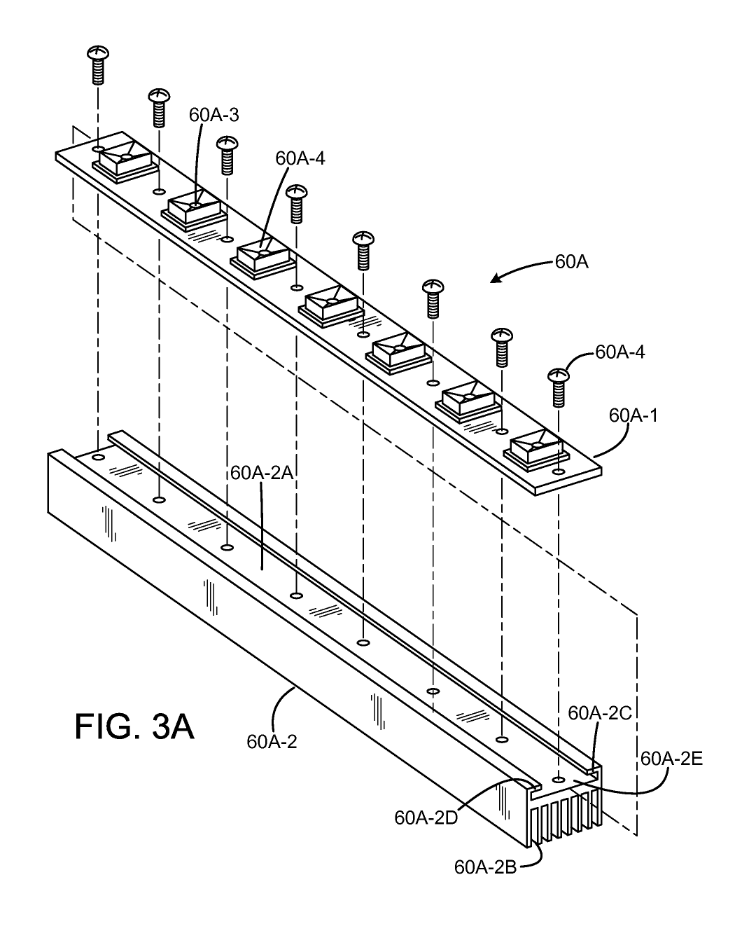

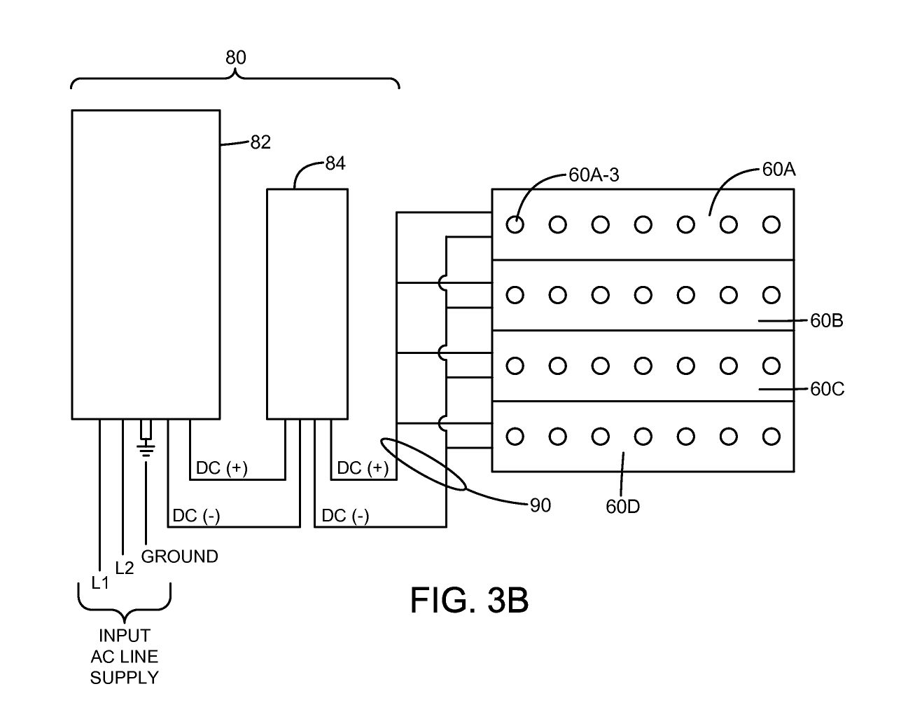

The LED modules 60A-60D in this exemplary embodiment each takes the form of elongated strips. Exemplary module 60A is illustrated in FIG. 3A; the other modules may be identical to module 60A. In this exemplary embodiment, LED module 60A includes seven LEDS 60A-3 disposed in a generally linear configuration, mounted on a printed wiring board 60A-1, in turn mounted to a heat sink housing 60A-2. In this embodiment, the heat sink housing is a unitary structure, fabricated of aluminum or the like, including a base surface or platform portion 60A-2A for mounting the printed wiring board carrying the LEDS thereon, and a set of cooling fins 60A-2B, to form a heat sink. The heat sink housing in this embodiment further has right angle tab portions 60A-2C and 60A-2D extending from surface 60A-2A to form a channel 60A-2E. The wiring board 60A-1 may be sized to slide into the channel from an end of the heat sink housing to its operating position, or may be narrower than the open end of the channel, to allow space for the support brackets, as described below.

The printed wiring board 60A-1 may have a buried conductor pattern for electrically connecting the LEDs on the board to a source of electrical power. The printed wiring board has mounted thereon in spaced relation seven 3 watt LEDs 60A-3 each with its own associated mini-reflector 60A-4. Although this exemplary embodiment shows seven LEDS in each array, for other embodiments, a greater or fewer number of LEDS may be employed, for example eight or ten LEDS per array. Fasteners 60A-4 may be used to mount the printed wiring board 60A-1 to the heat sink housing 60A-2.

The module 60A with heat sink housing 60A-2 provides a significant cooling feature to conduct heat generated by LED operation away from the LEDS.

The printed wiring board 60A-1 may be a multilayer structure, with a buried wiring pattern with conductive vias to connect to the LEDs mounted on the board. Of course, other types of wiring boards and patterns may be alternatively used to make the connections and mount the LEDs. The wiring connections to the LED modules from the power supply module 80 may be by connectors or terminal clips, allowing the electrical connections to be disconnected and reconnected to replace a given module in the field.

FIG. 3B is a simplified exemplary electrical schematic diagram for the LED lighting system 50. The electrical module 80 in this example includes a power supply 82, which is connected to a source of AC line voltage, at 120V or 220V, and provides a low voltage DC output, e.g. at nominal 27V. A power supply suitable for the purpose is the Mean Well S-150-27 power supply, by way of example only. The power supply output is in turn connected to the controller 84, which controls application of the DC supply to the LED modules 60A, 60B, 60C and 60D. The controller 84 may include a photocell to limit the time of operation of the streetlight to darkness hours, or may respond to commands from an external controller, or may include a timer set to control the time period of operation in which power is applied to the lighting sources, the LED modules. The LEDs in each module may be connected in parallel, and two wiring connections, plus and minus, are connected from the power supply to each module. Of course, other circuit configurations may also be employed.

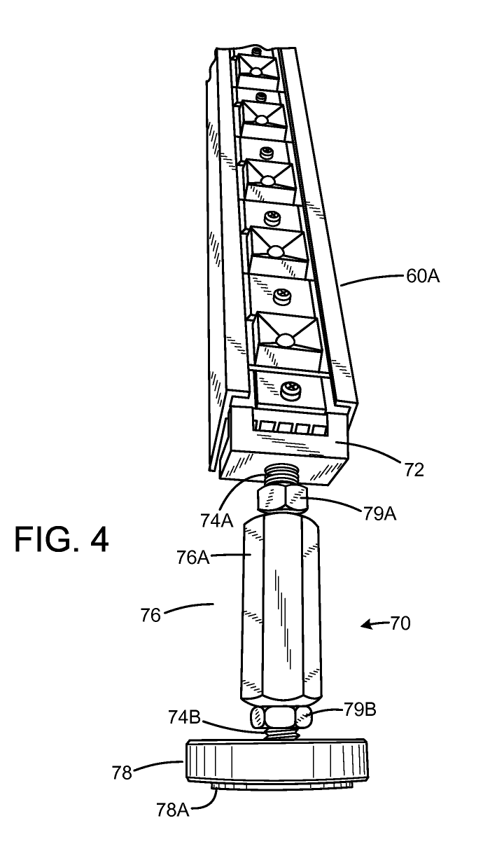

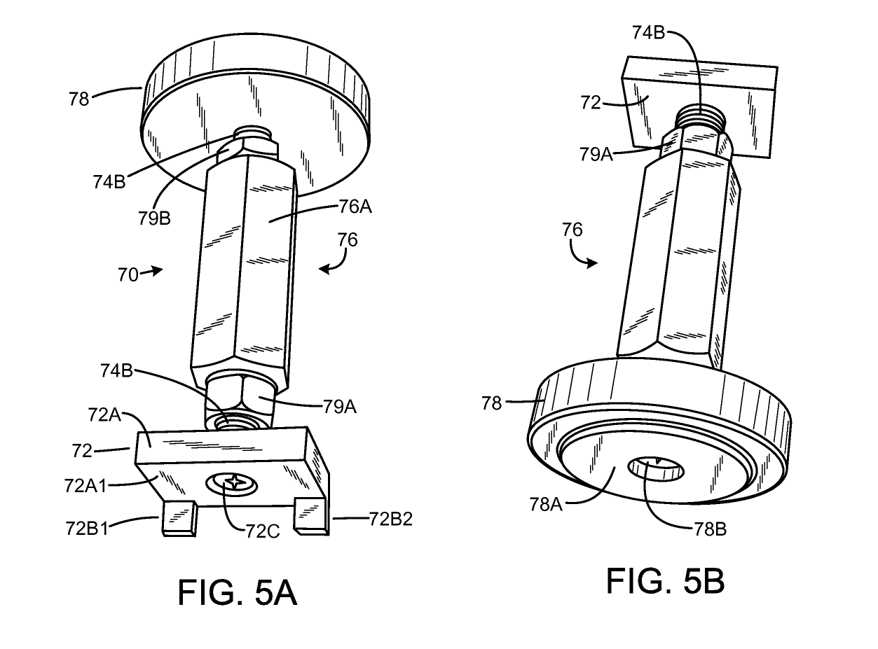

The LED light system 50 further includes a plurality of adjustable mount brackets 70, two per LED module in this exemplary embodiment, as shown in further detail in FIGS. 4, 5A and 5B. The brackets 70 include a first, module engaging end 72 for engaging an end of the LED module, and a second, support wall engaging end 78 for engaging against a wall of a support housing, in this embodiment, a wall of a box light housing structure. The brackets include a length adjustment mechanism for adjusting the distance between the first bracket end and the second bracket end. In this exemplary embodiment, the length adjustment mechanism includes a turnbuckle mechanism. Instead of providing a turnbuckle system at each end of the module, a single turnbuckle system can be providing at one end of the module, to push the opposite end of the module against the adjacent housing wall. The opposite module end can be provided with a resilient pad or a fixed length bracket to position the module end away from the adjacent housing wall.

In this exemplary embodiment, the module engaging end 72 of the bracket 70 includes a plate 72A having a pair of protruding tabs 72B1 and 72B2. Surface 72A1 of the plate is configured to contact one end of the heat sink housing of the LED module, and the ears 72B1 and 72B2 are configured to enter and be captured in the opposed ends of the channel 60A-2E (FIG. 3A). The wall engaging end 78 of the bracket 70 includes a plate 78, in this embodiment having a circular plate configuration, with an outer surface having a hard rubber flat member 78A attached to the surface, e.g. by adhesive or the like. The rubber member provides a high coefficient of friction, to engage against the box light housing wall.

The length adjusting mechanism 76 of the bracket structure 70 is a turnbuckle system, including a threaded center sleeve nut 76A, first and second threaded studs 74A and 74B, and lock nuts 79A, 79B. First ends of the studs are threaded into opposed ends of the center sleeve nut, with threading engagements of left hand and right hand senses. Distal ends of the studs are attached to the module engaging end 72 and the wall engaging end 78, respectively, e.g. by screws 72C and 78B. Turning the center sleeve nut in a first direction while holding stationary both the module engaging end and wall engaging end will extend the stud distal ends away from the center sleeve nut, and turning the center sleeve nut in a second direction with move the stud distal ends closer to the center sleeve nut. Two of the brackets 70 can be positioned to fix an LED module in position in the box housing 30 by turning the sleeve nuts to extend the bracket lengths until the wall engaging structures 78 tightly engage against the opposed walls of the box housing, e.g. walls 32A and 32B as illustrated in FIG. 1. Once the desired position of the module has been obtained, the lock nuts 79A and 79B can be tightened to fix the length of the bracket 70. The LED modules can be removed by reversing the procedure.

The LED modules can be fixed in different rotational positions (about the longitudinal axes of the modules) to angle the illumination in desired directions, before locking the module position by the lock nuts.

The length of the LED modules can be selected to accommodate different box housing structures. Exemplary box light housing dimensions are one by three feet, and one by two feet, but the light system can be sized to readily accommodate other box sizes. More or fewer than four LED modules can also be employed, depending on the application.

Although the foregoing has been a description and illustration of specific embodiments of the subject matter, various modifications and changes thereto can be made by persons skilled in the art without departing from the scope and spirit of the invention.

What is claimed is:

1. A light system for retrofitting to an existing box light housing, comprising:
a plurality of elongated light modules each comprising a plurality of separate light emitting diodes (LEDs);
for each of the light modules, first and second adjustable length bracket structures configured to fix the light module in position within the box light housing without other fasteners, each bracket structure comprising a first, module engaging end for engaging an end of the light module, a second, support wall engaging end for engaging against a wall of the box light housing, and a length adjustment mechanism for adjusting the bracket length or distance between the first, module engaging end and the second, support wall engaging end.

2. The system of claim 1, wherein said length adjustment mechanism includes a turnbuckle mechanism.

3. The system of claim 1, wherein each said length adjustment mechanism is configured to increase said distance sufficiently to extend the bracket lengths until the second, support wall engaging ends of the first and second adjustable length bracket structures tightly engage against opposed walls of the box light housing to hold the light module in place.

4. The system of claim 3, wherein each said length adjustment mechanism includes a locking feature to lock said mechanism to fix the bracket length at a desired length.

5. The system of claim 4, wherein said length adjustment mechanism includes a turnbuckle mechanism including a threaded center sleeve nut, and first and second threaded studs, and said locking feature includes first and second locking nuts respectively threaded onto the first and second threaded studs.

6. The system of claim 1, wherein the length adjustment mechanism are configured to fix the position of said light modules in different rotational positions about longitudinal axes of the modules to angle illumination generated by the modules in desired directions.

7. The system of claim 1, further comprising an electrical module connected to the light modules by wiring to provide electrical power to the light modules.

8. The system of claim 1, wherein the support wall engaging ends of each bracket structure includes a plate with an outer surface layer having a high coefficient of friction, to engage against a box light housing support wall.

9. The system of claim 1, wherein each light module is an elongated strip, with the plurality of LEDS disposed in a generally linear configuration, mounted on a printed wiring board, in turn mounted to a heat sink housing comprising a unitary structure including a base surface for mounting the printed wiring board carrying the plurality of LEDS, and a set of cooling fins.

10. The system of claim 9, wherein the heat sink housing includes features to engage the first, module engaging ends of the first and second adjustable length bracket structures.

11. A light system for a box light housing having a lens or window through which light passes, comprising:
a plurality of elongated light modules each comprising a plurality of separate light emitting diodes (LEDs);
for each of the light modules, at least one adjustable length bracket structure configured to fix the light module in position within the box light housing without other fasteners, each bracket structure comprising a first end for engaging an end of the light module, a second end for engaging against a wall of the box light housing, and a length adjustment mechanism for adjusting the bracket length or distance between the first end and the second end, wherein each said length adjustment mechanism is configured to increase said distance sufficiently to extend the bracket lengths until the second end tightly engages against a wall of the box light housing to hold the light modules in place.

12. The system of claim 11, wherein said length adjustment mechanism includes a turnbuckle mechanism.

13. The system of claim 12, wherein each said length adjustment mechanism includes a locking feature to lock said mechanism to fix the bracket length at a desired length.

14. The system of claim 13, wherein said length adjustment mechanism includes a turnbuckle mechanism including a threaded center sleeve nut, and first and second threaded studs, and said locking feature includes first and second locking nuts respectively threaded onto the first and second threaded studs.

15. The system of claim 11, further comprising an electrical module connected to the light modules by wiring to provide electrical power to the light modules.

16. The system of claim 11, wherein the second end of each bracket structure includes a plate with an outer surface layer having a high coefficient of friction, to engage against a box light housing support wall.

17. The system of claim 11, wherein said at least one adjustable length bracket structures includes first and second adjustable length bracket structures.

18. The system of claim 11, wherein each light module is an elongated strip, with the plurality of LEDS disposed in a generally linear configuration, mounted on a printed wiring board, in turn mounted to a heat sink housing comprising a unitary structure including a base surface for mounting the printed wiring board carrying the plurality of LEDS, and a set of cooling fins.

19. The system of claim 18, wherein the heat sink housing includes features to engage the first end of the at least one adjustable length bracket structure.

20. A light system for a box light housing, comprising:
at least one elongated light module comprising a plurality of separate light emitting diodes (LEDs);
for each of the at least one light module, first and second adjustable length bracket structures configured to fix the light module in position within the box light housing without other fasteners, each bracket structure comprising a first, module engaging end for engaging an end of the light module, a second, support wall engaging end for engaging against a wall of the box light housing, and a length adjustment mechanism for adjusting the bracket length or distance between the first, module engaging end and the second, support wall engaging end.
